(19) United States
(12) Patent Application Publication
(10) Pub. No.: US 2024/0274386 A1
(43) Pub. Date: Aug. 15, 2024

(54) Coil Assembly for an Electromechanical Relay, Electromechanical Relay with a Coil Assembly and Method for Manufacturing a Coil Assembly

(71) Applicant: TE Connectivity Austria GmbH, Waidhofen an der Thaya (AT)

(72) Inventors: Markus Gutmann, Waidhofen an der Thaya (AT); Philipp Harrer, Waidhofen an der Thaya (AT)

(73) Assignee: TE Connectivity Austria GmbH, Waidhofen an der Thaya (AT)

(21) Appl. No.: 18/436,187

(22) Filed: Feb. 8, 2024

(30) Foreign Application Priority Data
Feb. 10, 2023 (EP) 23156118.4

(51) Int. Cl. H01H 50/44; H01H 49/00; H01H 50/14

(52) U.S. Cl. CPC H01H 50/443; H01H 49/00; H01H 50/14

(57) ABSTRACT

A coil assembly for producing an electromagnetic driving force includes a core, an energizing coil wound about the core, and a distancing member separate from the core and the energizing coil and positioned between the core and the energizing coil. The distancing member radially spaces the energizing coil from the core. The distancing member has a layer of separation windings that are formed of a strand material.

### CROSS-REFERENCE TO RELATED APPLICATIONS

This application claims the benefit of the filing date under 35 U.S.C. § 119(a)-(d) of European Patent Application No. 23156118.4, filed on Feb. 10, 2023.

### FIELD OF THE INVENTION

The present invention relates to a coil assembly for producing an electromagnetic driving force in an electromechanical relay or other type of switching device, such as a contactor. Further, the present invention relates to an electromechanical relay comprising a coil assembly. Moreover, the present invention relates to a method for manufacturing a coil assembly.

### BACKGROUND

Electromechanical relays and other switching devices often rely on an electromagnetic driving force produced by a coil assembly. The coil assembly generally comprises an energizing coil wound about a core, wherein a distancing member is located between the core and coil. Usually, said distancing member is an insulation tube or cage made by injection-molding. The use of injection-molded tubes or cages leads to relatively large dimensions. This results in the distancing member negatively affecting the space- and energy-efficiency during operation thereof.

### SUMMARY

A coil assembly for producing an electromagnetic driving force includes a core, an energizing coil wound about the core, and a distancing member separate from the core and the energizing coil and positioned between the core and the energizing coil. The distancing member radially spaces the energizing coil from the core. The distancing member has a layer of separation windings that are formed of a strand material.

### BRIEF DESCRIPTION OF THE DRAWINGS

Features of the present invention will become more apparent by describing in detail exemplary embodiments thereof with reference to the accompanying drawings, in which:

FIG. 1 is a schematic rendition of a top view of a coil assembly according to a possible embodiment of the present disclosure;

FIG. 2 is a schematic rendition of a sectional side view of the coil assembly along the line A-A from FIG. 1;

FIG. 3 is a schematic rendition of a detail of the circle III from FIG. 2;

FIG. 4 is a schematic rendition of a perspective view of another detail of the embodiment shown in FIG. 3; and

FIG. 5 is a schematic rendition of a top view of a coil assembly according to another possible embodiment of the present disclosure.

### DETAILED DESCRIPTION OF THE EMBODIMENTS

In the following, exemplary embodiments of the invention are described with reference to the drawings. The shown and described embodiments are for explanatory purposes only. The combination of features shown in the embodiments may be changed as otherwise described herein. For example, a feature which is not shown in an embodiment but otherwise described may be added if the technical effect associated with this feature is beneficial for a particular application. Vice versa, a feature shown as part of an embodiment may be omitted if the technical effect associated with this feature is not needed in a particular application. In the drawings, elements that correspond to each other with respect to function and/or structure have been provided with the same reference numeral.

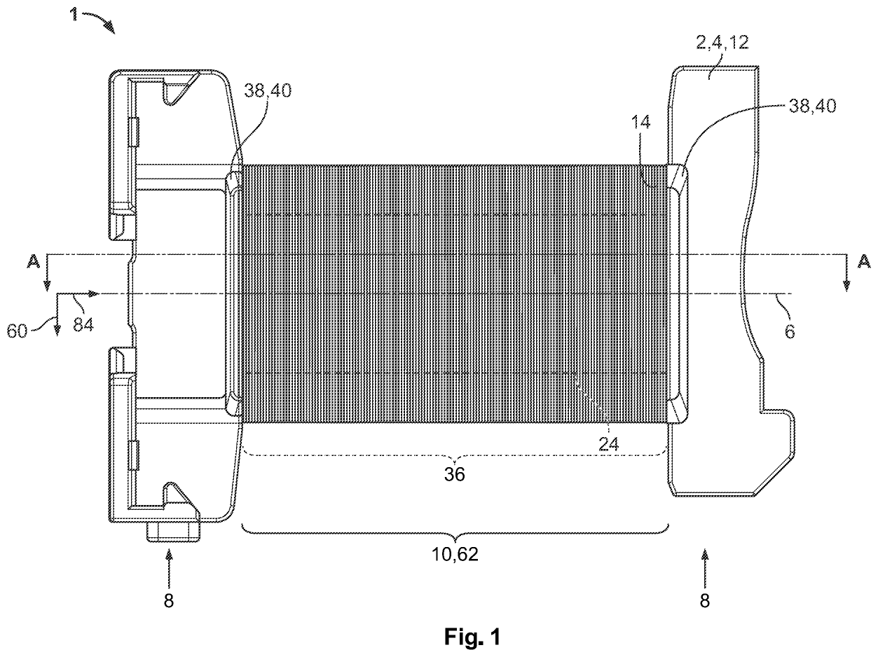

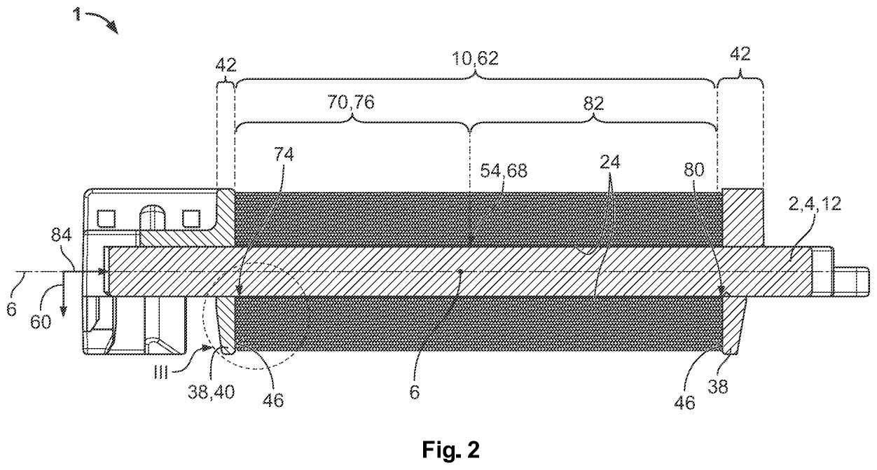

First, the structure of possible embodiments of a coil assembly 1 according to the present invention is explained with reference to the exemplary embodiments shown in FIGS. 1 to 5. Further below, FIG. 2 is used for explaining a method for manufacturing the coil assembly 1 according to the present invention.

FIG. 1 shows a top view of the coil assembly 1 according to one possible embodiment of the present disclosure. The coil assembly 1 is used in an electromechanical relay or another type of switching device requiring an electromagnetic driving force. As can be seen, the coil assembly 1 comprises a core 2. The core 2 may be a substantially oblong element 4 extending along a longitudinal axis 6 and having an H-shape. That is, the core 2 may have two T-shaped ends 8 located mutually oppositely along the longitudinal axis 6. Between the T-shaped ends 8, a cuboidal section 10 may extend (see FIG. 2).

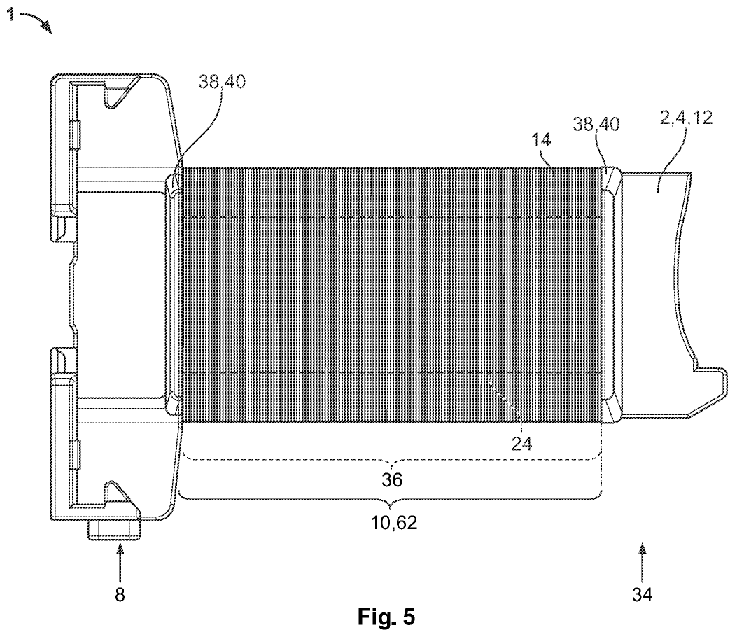

According to another embodiment shown in FIG. 5, the core 2 may alternatively comprise a T-shape. In other words, instead of two T-shaped ends 8, the core 2 may comprise only one T-shaped end 8 and a straight end 34 located mutually oppositely along the longitudinal axis 6. Between the straight end 34 and the T-shaped end 8, a cuboidal section may extend. If the energizing coil is supplied as a pre-wound coil, in this embodiment, it can be slid onto the core 2 from the straight end 34 as a whole.

The core 2 may be made of iron or any other ferromagnetic material with a relative permeability larger than 1, in an embodiment larger than 10, and in other embodiments larger than 100 or larger than 1000. The optional maximum number of layers should not exceed 100. In particular, the core 2 may be an iron core 12. This amplifies the electromagnetic driving force produced by the coil assembly 1.

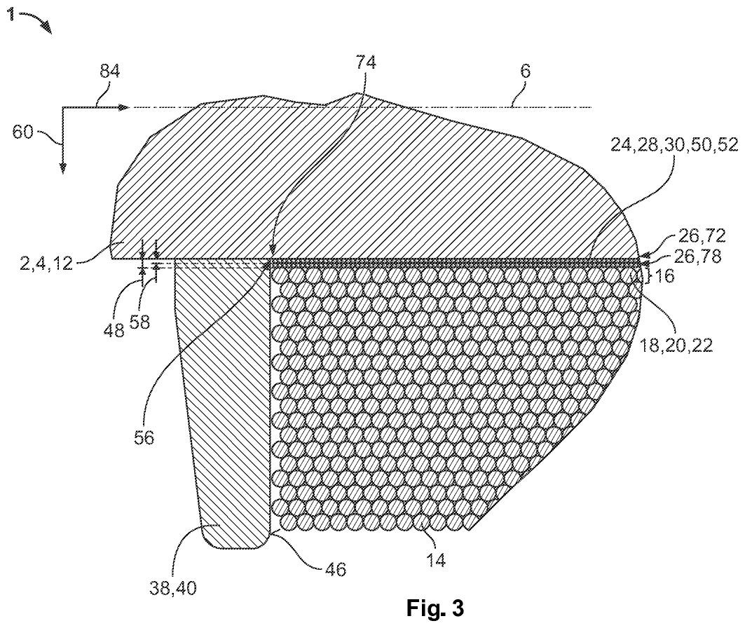

Further, the coil assembly 1 comprises an energizing coil 14 wound about the core 2 as shown in FIG. 1. The energizing coil 14 may comprise at least one layer 16 of energizing coil windings 18, as shown in FIG. 3. These energizing coil windings 18 may comprise enameled metal wire 20, in an embodiment enameled copper wire 22. Due to the electrically insulative lacquer of the enameled metal wire 20, the energizing coil windings 18 are inherently insulated from each other and from the core 2. Depending on the desired electromagnetic driving force the coil assembly 1 should be capable of producing, the energizing coil 14 may comprise more than 5, more than 10, more than 20, in an embodiment more than 50, and in other embodiments more than 100 or more than 200 layers 16 of energizing coil windings 18.

As can be best seen in FIG. 3, the coil assembly 1 further comprises a separate distancing member 24 located between the core 2 and the energizing coil 14 for radially spacing apart the energizing coil 14 from the core 2 for mechanical and/or electrical separation. That is, the distancing member 24 can fulfil an insulation function, but its purpose can also be limited to a purely mechanical function, which is fulfilled, e.g., during manufacturing of the coil assembly 1 as will be described in further detail below.

The distancing member 24 comprises at least one layer 26 of separation windings 28 made of strand material 30, as shown in FIG. 3. Due to the use of the strand material 30, the distancing member 24 in the form of the at least one layer 26 of separation windings 28 can be manufactured much thinner than conventionally molded distancing members, which often are subject to certain minimal material thickness requirements stipulated by manufacturability, refractoriness, and the like.

In an embodiment, the core 2 at least sectionally may have a cylindrical shape with a circular, oval, or elliptical cross-section perpendicular to the longitudinal axis. The at least one layer 26 of separation windings 28 may be located on said cylindrical shape. In an embodiment, no sharp edges, which could potentially damage the strand material are present on the core 2 in this embodiment.

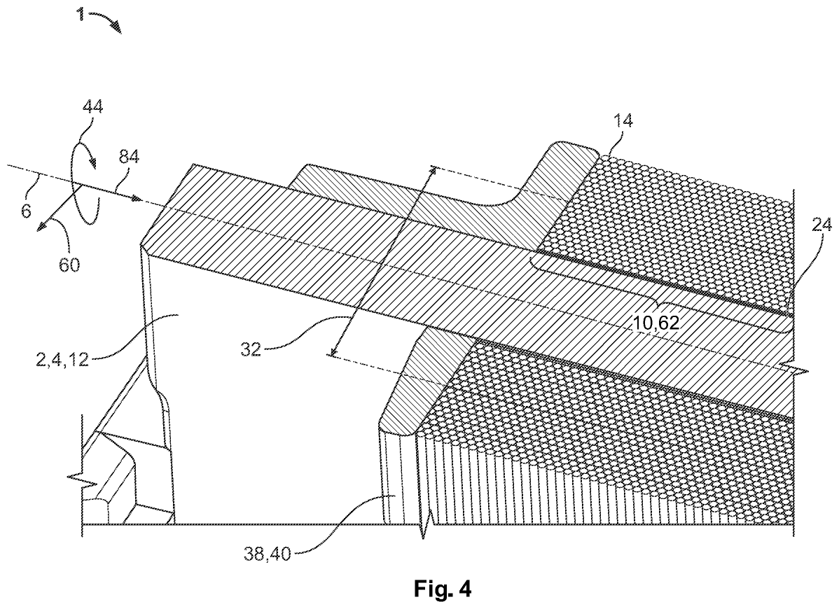

With its thin distancing member 24, the coil assembly 1 of the present invention saves installation space and improves coil efficiency, since the energizing coil 14 can be wound closer to the core 2, which results in a smaller mean inner diameter 32 of the energizing coil 14 (see FIG. 4). Further, manufacturing costs are decreased, while productivity is increased, since no costly, lengthy molding process needs to be carried out for the production of the distancing member 24 in the form of the at least one layer 26 of separation windings 28.

The at least one layer 26 of separation windings 28 can be obtained by winding the strand material 30 around the cuboidal section 10 of the core 2. In particular, the strand material 30 may be helically wound about the cuboidal section 10 of the core 2. The at least one layer of separation windings 28 can be created in the same winding machine as the energizing coil 14, which is also helically wound (later on). In particular, one mounting step and one un-mounting step can be saved this way.

Alternatively, the strand material 30 may be formed as multiple ring-shaped pieces that are arranged coaxially with the core 2. The ring-shaped pieces may be circumferentially closed and slid onto the core from the above-mentioned straight end 34, when a T-shaped core 2 is used. Otherwise, the ring-shaped pieces may be laterally open and snapped onto or bent around the core 2. For the manufacturing of this embodiment, no winding machine is required, especially if the energizing coil 14 is supplied as a pre-wound coil.

Accordingly, the enameled metal wire 20 of the energizing coil windings 18 is helically wound about the longitudinal axis 6 on a section 36 of the distancing member 24. Accordingly, the separation windings 28 and the energizing coil windings 18 may have the same winding pitch. Thereby, no pitch change is necessary during manufacturing when the separation windings 28 are completed and the energizing coil windings 18 are to be wound next. Alternatively, the separation windings 28 and the energizing coil windings 18 may each have a different winding pitch. This results in a more reliable separation between the core 2 and the energizing coil 14 since it is less likely that the coil wire of the energizing coil windings 18 slips in between adjacent separation windings 28 as would be the case if the winding pitch was the same.

In order to guarantee a reliable separation between the core 2 and the energizing coil 14 even if the winding pitch is the same, the strand material 30 may gaplessly surround the core 2 between the core 2 and the energizing coil 14. Having no gaps prevents the coil wire of the energizing coil from slipping in between adjacent separation windings. Alternatively, gaps may be present between individual separation windings 28 as long as those gaps are sufficiently smaller than the diameter of the energizing coil's coil wire.

As can be seen in FIG. 2, the coil assembly 1 may comprise at least one positioning member 38 arranged on an end 8, 34 of the core 2, said end 8, 34 extending out of the at least one layer 26 of separation windings 28. The at least one positioning member 38 may be, e.g., a spool collar 40 made of insulation material. The spool collar 40 may have a collar section 42 that is substantially disk-shaped and extends in a circumferential direction 44 around the longitudinal axis 6. Further, the collar section 42 may comprise a front face 46 oriented towards an axial direction 84 parallel to the longitudinal axis 6. The energizing coil 14 and the distancing member 24 may each abut against the front face 46 of the collar section 42 in the axial direction 84.

In order to maintain the above mentioned gaplessness, the coil assembly 1 has two such positioning members 38, each arranged on opposite ends 8, 34 of the core 2 with respect to the longitudinal axis 6. Thus, it can be prevented that the energizing coil 14 and the distancing member 24 slide on or even off the core 2 in the axial direction 84.

Depending on the required thickness 48 and function of the distancing member 24, at least two layers 26 of separation windings 28 may be provided as is shown in FIG. 3. That is, if the distancing member 24 is to fulfill the role of an electrical insulation between the energizing coil 14 and the core 2, more than one layer of separation windings 28 may be needed, in order to achieve a required dielectric strength for preventing electrical breakdown at the coil assembly's operating voltage. If, however, the distancing member 24 has the sole purpose of a purely mechanical separation between the energizing coil 14 and the core 2, a single layer 26 of separation windings 28 may be sufficient.

In order to establish the purely mechanical separation between the energizing coil 14 and the core 2, the strand material 30 may be pliable so as to be wound about the core 2, particularly about the cuboidal section 10 of the core 2, without forming sharp corners. That is, the strand material 30 should only form rounded bends when wound about the core 2. As such, the strand material 30 can cover sharp edges of the core 2, particularly of its cuboidal section 10, that would otherwise damage the lacquer of the energizing coil windings 18, when winding the energizing coil 14 about the core 2.

In the shown embodiments, the strand material 30 used for the separation windings 28 comprise a metal wire 50, in particular an enameled copper wire 52 like the energizing coil windings 18, however, the strand material 30 is not interconnected with the energizing coil windings 18. That is, the energizing coil windings 18 and the separation windings 28 are different component. For example, the strand material 30 may be a coil wire with a diameter of 10 to 100 micrometers, or 21 to 90 micrometers, whereas the energizing coil 14 may comprise a separate coil wire with the same or a larger diameter. This is advantageous, since it allows to utilize the same raw material or at least the same type of raw material for the energizing coil windings 18 and the separation windings 28.

Alternatively, or additionally, the strand material 30 may comprise a flat ribbon cable and/or an insulation tape and/or a plastic wire with a circular cross-section. The strand material may be braided or stranded. Thus, the coil assembly 1 offers a wide choice of raw materials, which can be freely chosen based on aspects such as price, performance, and availability.

In another embodiment, the at least one positioning member 1 may comprise at least one fixation pin. The at least one fixation pin may be monolithically formed by a pin-shaped section of the at least one positioning member 38. Further, at least one end 54 of the strand material 30 may be fixed to the at least one fixation pin in order to prevent unwinding of the strand material 30 at least one-sidedly. Said fixation of the strand material end 54 can be achieved by tying, winding, gluing or the like. Thus, unwinding of the strand material wound around the core can be prevented at least one-sidedly.

If an even number of separation winding layers 26 is provided and both ends 54 of the strand material 30 are relatively close to each other, unwinding of the strand material 30 can be prevented two-sidedly by commonly fixing both ends 54 of the strand material 30 to the same fixation pin. Since no electric current will flow through the strand material 30, there is no risk of shorting, even if the strand material ends 54 are in direct contact. Nevertheless, the at least one positioning member 38 may also comprise two fixation pins, wherein both ends 54 of the strand material 30 are fixed to different fixation pins. Instead of fixing both ends 54 of the strand material 30 to the fixation pin or fixation pins, both ends 54 of the strand material 30 may be jointed together e.g., by being tied to one another. This allows simplifying the structure of the at least one positioning member 38.

If an odd number of separation winding layers 26 and two positioning members 38 are provided, each of the two positioning members 38 may comprise its own fixation pin each for one end 54 of the strand material 30. Both ends 54 of the strand material 30 may then be fixed to their nearest fixation pin, respectively.

As can be seen in FIG. 3, the at least one positioning member 38 may reach into a corner 56 between the core 2 and the at least one layer 26 of separation windings 28. By occupying said corner 56 with the at least one positioning member 38, it is prevented that windings of the energizing coil 14 slide off the separation windings 28 into said corner 56.

In an embodiment, the at least one positioning member 38 and the distancing member 24 are separate components. In an embodiment, the distancing member does not comprise any molded part. FIG. 3 shows that only the strand material 30 and no injection-molded resin or plastic part is positioned between the core 2 and the energizing coil 14. Such a part would be potentially flammable, and thus would have to fulfill certain requirements for minimal material thickness according to any technical standards (e.g., the so-called UL Yellow Card) that are not required when a strand material is used.

Accordingly, the at least one layer 26 of separation windings 28 may have a thickness 58 of 50 micrometers or less, or from 10 to 150 micrometers in another embodiment. Herein, the thickness 58 is measured in a radial direction 60 perpendicular to the longitudinal axis 6. In comparison, conventional coil assemblies with molded distancing members usually have a thickness of at least 0.25 to 0.40 millimeters.

An electromechanical relay according to the present invention comprises a coil assembly 1 according to any one of the above-described embodiments and two electrically conductive coil terminal pins, wherein ends of the energizing coil are each fixed to different coil terminal pins. The electromechanical relay benefits from the advantages of the coil assembly, providing it with a high electrical efficiency, compact layout, cheap production costs and short manufacturing time. The ends 54 of the strand material 30 as well as the entire separation windings 28 are potential-free even if they include conductive material (e.g., copper). That is, the ends 54 of the strand material 30 do not need to be fixed to any coil terminal pins at all. Yet, the ends 54 of the strand material 30 can alternatively both be fixed to the same coil terminal pin.

Next, the method for manufacturing a coil assembly 1 according to the present invention will be described with reference to FIGS. 2 and 3.

The method comprises the steps of providing a core 2 that extends along a longitudinal axis 6, winding a strand material 30 about the longitudinal axis 6 on a section 62 of the core 2 to create at least one layer 26 of separation windings 28 of a distancing member 24, and helically winding an enameled metal wire 20 about the longitudinal axis 6 on a section 36 of the distancing member 24 to create an energizing coil 14. In the resulting coil assembly 1, the energizing coil 14 is spaced apart from the core 2 by the distancing member 24. In an embodiment, the strand material 30 is also wound helically. For example, the strand material 30 may be an enameled metal wire 50, such as a copper wire 52, a flat ribbon cable or an insulation tape.

The at least one layer 26 of separation windings 28 may be created by starting the winding of the strand material 30 at or near the center 64 of the core 2. Additionally, the winding of the strand material 30 may also be stopped at or near the center 64 of the core 2. That is, the winding may be started and/or ended exactly in the middle 66 of the core 2 or at least at a position 68 that is closer to the middle 66 of the core 2 than to any end 8, 34 of the core 2.

From said position 68, the strand material 30 is helically wound onto the core 2 and towards one end 8 of the core 2 to form a first half 70 of a first layer 72 of the separation windings 28 (see FIG. 3). After reaching a certain outer-most position 74 (e.g., where one positioning member 38 is located), the strand material 30 is now wound towards the starting position 68 atop the first half 70 of the first layer 72 of the separation windings 28. Thus, a first half 76 of a second layer 78 of the separation windings 28 is created. Upon passing the starting position 68, the strand material 30 is again directly wound onto the core 2 towards an opposite outer-most position 80, in order to complete the second half 82 of the first layer 72 of the separation windings 28.

This process may be repeated, until the desired number of separation winding layers 26 have been obtained half by half. Thereby, the inventive method results in a coil assembly 1 with fewer loose ends, since the starting end and/or the ending end of the strand material 30 are self-retainingly held by the separation windings 28 of upper layers and/or later on by the energizing coil 14.

In the coil assembly of the present invention, the energizing coil is spaced apart from the core by the distancing member for mechanical and/or electrical separation. That is, the distancing member can fulfill an insulation function, but its purpose can also be limited to a purely mechanical function, which is fulfilled, e.g., during manufacturing of the coil assembly. Due to the use of a strand material, the distancing member in the form of the at least one layer of separation windings can be manufactured much thinner than conventionally molded distancing members, which often are subject to certain minimal material thickness requirements stipulated by manufacturability, refractoriness, and the like.

The present invention enhances the performance of electromechanical relays in general, improving their coil assemblies in terms of space and energy consumption. With its thin distancing member, the coil assembly of the present invention not only saves installation space, given the smaller dimensions, but also improves coil efficiency, since the energizing coil can be wound closer to the core, which results in a smaller mean inner diameter of the energizing coil.

What is claimed is:

1. A coil assembly for producing an electromagnetic driving force, comprising:
a core;
an energizing coil wound about the core; and
a distancing member separate from the core and the energizing coil and positioned between the core and the energizing coil, the distancing member radially spaces the energizing coil from the core, the distancing member has a layer of separation windings that are formed of a strand material.

2. The coil assembly according to claim 1, wherein the layer of separation windings has a thickness of 50 micrometers or less.

3. The coil assembly according to claim 1, wherein the strand material is at least one of a metal wire, a flat ribbon cable, and an insulation tape.

4. The coil assembly according to claim 1, wherein the strand material if formed as a plurality of ring-shaped pieces arranged coaxially with the core.

5. The coil assembly according to claim 1, wherein the strand material is helically wound about the core.

6. The coil assembly according to claim 1, wherein the separation windings and the energizing coil have a different winding pitch or a same winding pitch.

7. The coil assembly according to claim 1, wherein the strand material gaplessly surrounds the core between the core and the energizing coil.

8. The coil assembly according to claim 1, further comprising a positioning member arranged on an end of the core.

9. The coil assembly according to claim 8, wherein the end extends out of the layer of separation windings.

10. The coil assembly according to claim 9, wherein the positioning member has a fixation pin, an end of the strand material is fixed to the fixation pin.

11. The coil assembly according to claim 9, wherein the positioning member extends into a corner between the core and the layer of separation windings.

12. The coil assembly according to claim 1, wherein the distancing member does not have a molded part.

13. The coil assembly according to claim 1, wherein a pair of ends of the strand material are jointed together.

14. An electromechanical relay, comprising:
a coil assembly including a core, an energizing coil wound about the core, and a distancing member separate from the core and the energizing coil and positioned between the core and the energizing coil, the distancing member radially spaces the energizing coil from the core, the distancing member has a layer of separation windings that are formed of a strand material; and
a pair of electrically conductive coil terminal pins, a pair of ends of the energizing coil are each fixed to different coil terminal pin of the pair of electrically conductive coil terminal pins.

15. The electromechanical relay according to claim 14, wherein a pair of ends of the strand material are not fixed to any of the electrically conductive coil terminal pins.

16. The electromechanical relay according to claim 14, wherein a pair of ends of the strand material are both fixed to a same coil terminal pin of the pair of electrically conductive coil terminal pins.

17. A method of manufacturing a coil assembly, comprising:
providing a core that extends along a longitudinal axis;
winding a strand material about the longitudinal axis on a section of the core to create a layer of separation windings of a distancing member; and
helically winding an enameled metal wire about the longitudinal axis on a section of the distancing member to create an energizing coil, the energizing coil is spaced apart from the core by the distancing member.

18. The method of claim 17, wherein the layer of separation windings is created by starting the winding near a center of the core.
